(19) United States
(12) Patent Application Publication
(10) Pub. No.: US 2006/0212815 A1
(43) Pub. Date: Sep. 21, 2006

(54) Dialog system and method for efficient computer interaction

(76) Inventors: Juan Manuel Huerta, Bronx, NY (US); David Lubensky, Brookfield, CT (US); Marta Rey-Babarro, Ourense (ES)

Correspondence Address: KEUSEY, TUTUNJIAN & BITETTO, P.C., 20 CROSSWAYS PARK NORTH, SUITE 210, WOOBURY, NY, 11797, US

(21) Appl. No.: 11/081,329

(22) Filed: Mar. 16, 2005

(51) Int. Cl. G06F 9/00

(52) U.S. Cl. 715/744; 715/866; 715/745

(57) ABSTRACT

An interactive computer system and method includes a plurality of program components hierarchically arranged. Each component provides a specific task or set of tasks responsive to information provided to the components. A dialog manager arranges the components in accordance with the tasks needed to be performed and decides an order of performance for the tasks based on user-specific usage patterns.

### BACKGROUND

1. Technical Field

Exemplary embodiments presented herein relate to computer-human interaction and more particularly to systems and methods for more efficiently capturing user intent based upon prior history for interactive computer devices.

2. Description of the Related Art

Computer systems rely on user input to define how and when tasks will be performed. Inputs from a user may take many forms including data entry from a keyboard, selection information made using a mouse, speech, etc. However, providing a system with detailed instructions each and every time the instruction or task is carried out is not only time-consuming, but also annoying to users.

Some systems provide user interfaces having fields filled out with information that was last or previously entered into the field to attempt to reduce time needed for reentry of this information. However, while this may be convenient for repetitive type data entry, in many instances this is counterproductive since this information may have to first be deleted prior to filling out the field.

Therefore, it would be advantageous to provide a system and method capable of intuitively making assumptions regarding user selections in a human-computer interface.

### SUMMARY

An interactive computer system and method includes a plurality of program components hierarchically arranged. Each component provides a specific task or set of tasks responsive to information provided to the components. A dialog manager dynamically arranges the components in accordance with the tasks needed to be performed and decides an order of performance for the tasks based on previously or currently established user-specific usage patterns.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing a component hierarchy in the form of a tree for use in accordance with illustrative embodiments;

FIG. 2 is a block diagram of an illustrative system showing a voice browser and telephone interface with a server application in accordance with one implementation; and

FIG. 3 is a block/flow diagram for an illustrative method, which restructures a master description in accordance with user usage patterns.

### DETAILED DESCRIPTION OF PREFFERED EMBODIMENTS

Illustrative embodiments provided herein include systems and methods for human-computer dialog management, which is improved as a result of breaking down information into classes and then employing a history of previous actions or events to make intuitive assumptions about related tasks or selections. In this way, a more intelligent interface is provided, which promotes efficiency and creates a more fluid interaction between a user and a computer device.

The present disclosure will be described in terms of a system, which supports a voice application; however the present systems and methods may include any type of input method and data. In addition, computer and described herein may include any computing device, such as a handheld computer or personal digital assistant (PDA), cellular telephone, or any other device capable of processing information for human communication and interaction with a computer or computer system.

It should be understood that the elements shown in the FIGS. may be implemented in various forms of hardware, software or combinations thereof. Preferably, these elements are implemented in a combination of hardware and software on one or more appropriately programmed general-purpose digital computers having a processor and memory and input/output interfaces.

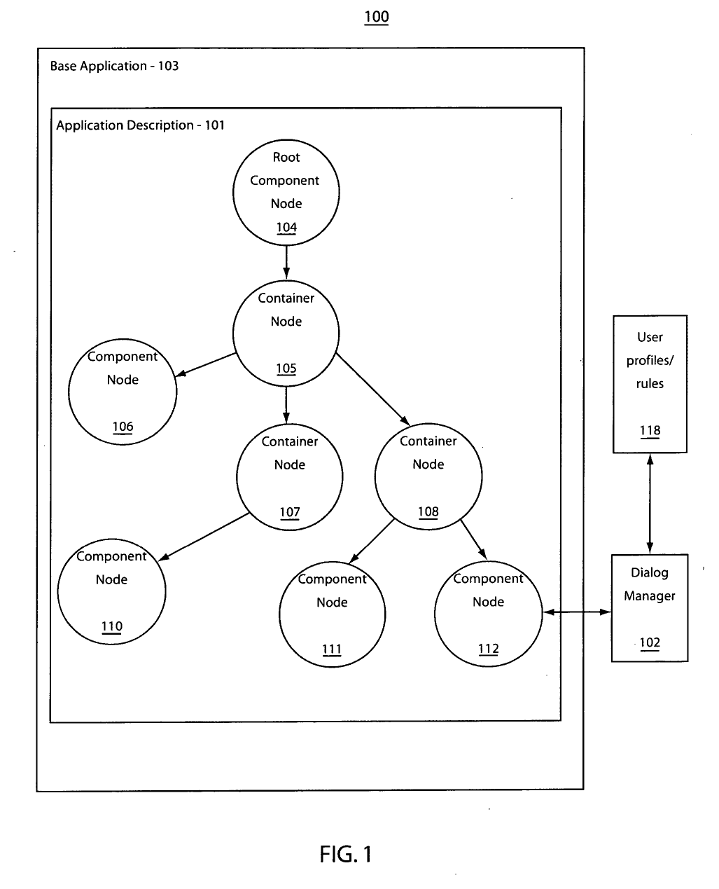

Referring now to the drawings in which like numerals represent the same or similar elements and initially to FIG. 1, an illustrative system 100 includes a dialog manager 102 and one or more base applications 103. The base application may include, for example, a travel reservation program, a banking application program, or any other user-interactive program. The base application 103 includes a master description 101. The master description 103 includes the default version of the application 103. This default version may be run for users which are new to the system or do not have a stored profile.

The master application 101 preferably includes a hierarchical arrangement, which may include a tree structure. The master application is comprised of a plurality of components nodes 104, 106, 110, 111 and 112 and container nodes 105, 107, and 108. The nodes and connections between nodes are provided for illustration purposes and should not be construed as limiting. Each component may include an executable program or programs that employ information provided by other components, a user or other portions of the system.

The components and containers are preferably modular and can be arranged in different orders. In addition, the structure may be modified to add or delete as needed in accordance with user usage patterns.

System 100 may be part of a voice application. In one embodiment, the components and containers are structured in a tree structure (e.g., hierarchical structures). At each node of the tree, the dialog manager 102 is responsible to manage the execution of the children of that node. For example, node 104 may be executed and dialog manger 102 is responsible for deciding which of the children nodes 106, 107 and/or 108 to execute. Container node 105 (also container nodes 107 and 108) may direct the execution path based on historical transactions performed by a given user under similar circumstances. Alternately, the dialog manager may skip nodes and container nodes based on information previously stored regarding a user, or make decisions based on past actions of a specific user and the data currently entered by the user.

The dialog manager 102 may include an algorithm that may be implemented inside a class. In one illustrative implementation, the dialog manager 102 takes an application (which is written in terms of trees) and executes the application. The dialog manager 102 may run a strategy that will execute the components (nodes) in a way that is conditioned on how and which interactions have taken place between the user and the application previously.

Thus, the application may take the static application tree and break it down into a plurality of information types. For example, three types of information may be employed: template, discriminating and parametric information. Template information is information that never changes, regardless of the interaction that the user has had with the system in the past.

Discriminating information includes the fields and values that aid the dialog manager 102 to identify and follow user specific paths in the application. So, for example, in a car rental application, if a user has always expressed interest in renting a convertible every time that his destination is Florida, the next time the system identifies his destination in a new reservation as Florida, and the system 100 can obviate one interaction by assuming that the specific user wants a convertible car.

In terms of FIG. 1, for a travel/reservation application, the component (e.g., node 104) may ask a user his/her destination. If the destination has associated data with it (e.g., if Florida select a convertible), appropriate action is taken at container node 105. This may bypass portions of the tree structure by obviating steps in the process.

In this case the discriminating information is the location, the template information becomes the type of car (convertible once the system determines that the user wants to go to Florida), and the parametric information is that information that the system needs to obtain, e.g., the pickup and return dates for the rental car.

The dialog manager 102 will also infer (or learn) several patterns about those callers that interact more with the system and offer them the transaction that those callers will most likely be making.

In the current recycled dialog component (RDC) hierarchy, the dialog manager 102 generates a static tree for the call flow. With this new strategy, the dialog manager 102 would detect rules 118 that the system 100 has generated learning for past interactions, and will generate a dynamic tree for each customer or each scenario depending on the application and use, thus providing a personalized interaction. In this way, the system 100 leverages information previously used by collected information e.g., cookies, credit card numbers, etc., plus transaction history information. For example, what transactions were completed, what was purchased, what preferences were selected, keystroke information, or any other clue or information that may be collected. Based on a general application component hierarchy, the system can infer a usage pattern that is used to create a new application call flow that is optimal for the specific user/transaction.

For example, if a user always travels to Austin, Tex. on February 26^{th}, the system 100 would remember this information and automatically adjust the hierarchical tree in anticipation. This may include asking the dates of travel first, and if the dates of travel include February 26^{th}, the dialog manager 102 may bypass components related to the destination since the destination is most likely Austin, Tex. This selection may be weighted by the number of times this data has been true.

Adjustment of the hierarchical tree may further include executing a common pattern of queries or collecting information in a more efficient manner (e.g. ordering queries made of the user in a way that reduces time and/or eliminates the need to ask all of the needed questions).

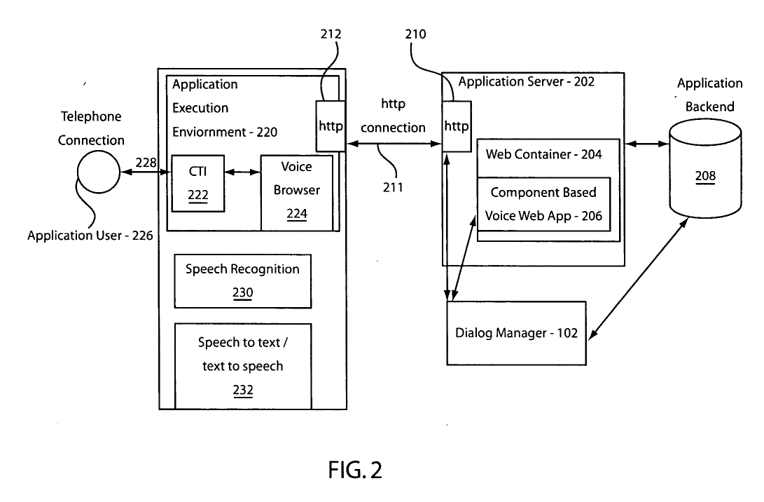

Referring to FIG. 2, an exemplary system configuration in an application deployment environment is shown. An application server 202 hosts a web container 204 that in turn, hosts a voice application 206. This voice application 206 may be implemented in terms of software components (and thus, it is a component based voice web app). Application 206 may include a dialog manager 102 (FIG. 1). The application server 202 submits via an http connection 211 markup text (http 210) that is to be executed in an application execution environment 220. This markup 210 is generated by the component based voice web application 206.

The application execution environment 220 includes an interface to a telephony channel (or CTI) 222, and a voice browser 224 that follows the markup 210 produced by the application server. In addition, speech recognition engines 230 and text to speech engines 232 can exist in the application execution environment 220. The application execution environment 220 interacts with the user preferably via a telephone connection 228, and receives markup 210 and submit values 212 to the application server 202 via the http connection 211.

While system 200 illustratively provides a web-based application using a telephone connection, a plurality of different embodiments may be provided. For example, the telephone connection may include a wireless, such as cellular or satellite communications, and the web based application may include a local area network service or the like. A user 226 may log into a service website using a telephone connection 228. In the application execution environment 220, the user interfaces with the application server 202 by having voice information converted to text via speech recognition 230 and speech to text conversion 232. Markup text 210 for the component based application 206 is downloaded and data is entered as needed and sent back to server 202. Values 212 received from the user are employed as clues for predicting the purpose and intent of the user. Depending on the user's identity, the user's history and the information provided, the component-based application 206 makes predictions and arranges the session to provide a more efficient interaction with the user. User information may be categorized and stored in a memory storage device or system 208.

A plurality of program components in the hierarchically arranged base application are preferably rearranged in accordance with user-specific usage patterns to more effectively interact with each user. Application 206 is optimized by a dialog manager such that user-specific usage patterns capture discriminant information. The discriminate information can be used to bypass or skip obtaining template information, which can be inferred based on past history of usage by the user. Then, parameter information can be captured for continued processing. For future interaction with a specific user or class of users, the information and activity performed is stored in memory 208 and the component tree structure is modified and stored accordingly for future transactions.

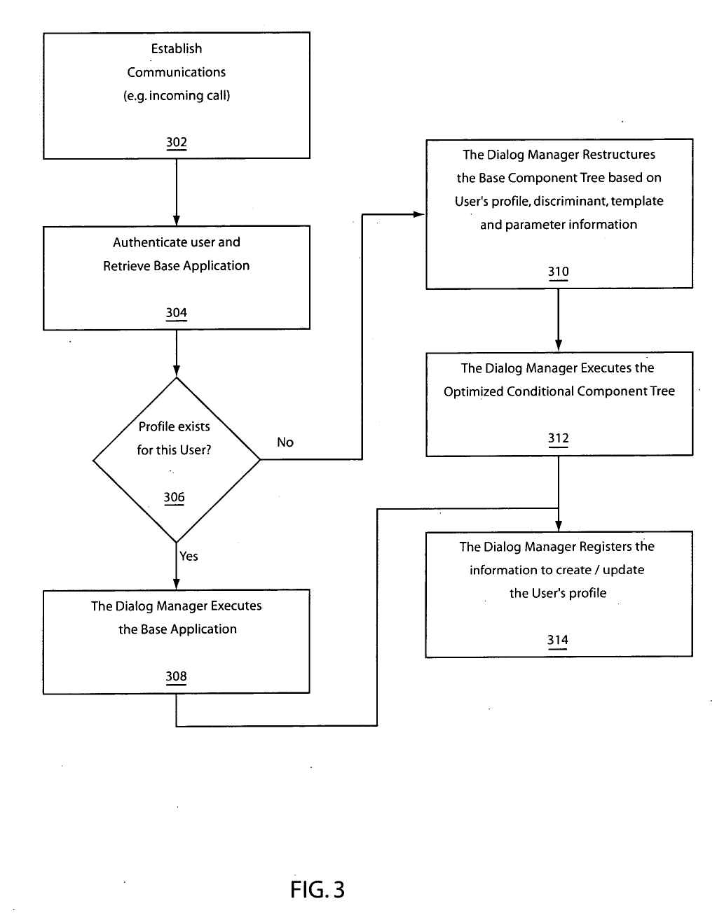

Referring to FIG. 3, a block/flow diagram for a system/method in accordance with useful embodiments is illustratively depicted. In block 302 an incoming call is received from a user wishing to access an application such as a component based application. Block 302 may run continuously looking for an incoming call. Once the call is received, the user may be authenticated and at least identified. Once the user is identified, the base application the user desires to access is retrieved based on the user's identity or based on initial questions or input from the user. Alternately, the base application may be known and retrieved by simply accessing the appropriate server.

In block 306, a check is made to see if a profile exists for the user. If a profile does not exist, the dialog manager in block 308 executes the base application. If a profile exists, the dialog manager restructures the base component tree based on a user's profile template in block 310. The user's profile may include discriminate, template and/or constant (or parameter) information.

After the restructured tree is provided, the dialog manager executes the optimized conditional component tree in block 312. In block 314, the dialog manager registers the information to create/update the user's profile template. Over time, the template can accurately or more accurately predict behavior patterns of the user. In particular, the actions of the user will be predictable by the system.

Having described preferred embodiments of a dialog system and method for efficient computer interaction (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. An interactive computer system comprising:
a plurality of program components hierarchically arranged, each component providing a specific task or set of tasks responsive to information provided to the components; and
a dialog manager that arranges the components in accordance with the tasks needed to be performed and decides an order of performance for the tasks based on previously or currently established user-specific usage patterns.

2. The system as recited in claim 1, wherein the program components include a master description of an application wherein a modification to the master description is made based on the user-specific usage patterns.

3. The system as recited in claim 2, wherein the modification of the application includes user conditioned pattern structures, which include a template section, a discriminant section, and a parameter section.

4. The system as recited in claim 3, wherein the user condition pattern structures are arranged to capture discriminant information, which is applied to skip template information, and capture the parameter information.

5. The system as recited in claim 1, wherein the dialog manager arranges the components into a user conditioned pattern structure for future interaction with a specific user or class of users.

6. The system as recited in claim 5, wherein the components are arranged to capture discriminant information and apply the discriminant information to skip component that rely solely on template information, and capture the parameter information.

7. The system as recited in claim 1, wherein the program components include executable computer programs and the computer programs are arranged in a tree structure, which is modified by the dialog manager in accordance with the user-specific usage patterns.

8. The system as recited in claim 1, wherein the program components are modular and may be executed in a plurality of different orders.

9. An interactive computer system comprising:
an application server having a user accessible application, the user accessible application comprising a master description including a plurality of program components hierarchically arranged, each component providing a specific task or set of tasks responsive to information provided to the components; and
a dialog manager that arranges the components in the master description in accordance with user-specific usage patterns to more effectively interact with each user.

10. The system as recited in claim 9, wherein the master description is modified to include user conditioned pattern structures.

11. The system as recited in claim 10, wherein the user-specific pattern structures include template information, discriminant information, and parameter information.

12. The system as recited in claim 11, wherein the user-specific pattern structures are arranged to capture discriminant information, which is applied to skip template information, and capture the parameter information.

13. The system as recited in claim 9, wherein the user-specific usage patterns are based on past usage patterns by that user or class of users.

14. The system as recited in claim 9, wherein the program components are arranged to capture discriminant information and apply the discriminant information to skip components that rely solely on template information, and capture the parameter information.

15. The system as recited in claim 9, wherein the program components include executable computer programs and the computer programs are arranged in a tree structure, which is modifiable, by the dialog manager in accordance with the user-specific usage patterns.

16. The system as recited in claim 9, wherein the program components are modular and may be executed in a plurality of different orders.

17. The system as recited in claim 9, wherein the user interacts with the server through a voice browser.

18. A method for efficient interactions between a user and a computer system comprising the steps of:
establishing communications with a user;
executing a base application using user-supplied information; and
reconstructing a plurality of program components hierarchically arranged in the base application in accordance with user-specific usage patterns to more effectively interact with each user such that user-specific usage patterns capture discriminant information, which is applied to skip template information, and capture the parameter information for future interaction with a specific user or class of users.

19. The method as recited in claim 1, wherein the program components include a master description and the step of restructuring includes modifying the master description based on the user-specific usage patterns.

20. The method as recited in claim 18, wherein the program components include executable computer programs and the computer programs are arranged in a tree structure wherein the method further comprises the step of a dialog manager modifying the tree structure in accordance with the user-specific usage patterns.

21. The method as recited in claim 20, wherein the program components are modular and may be executed in a plurality of different orders.

22. A program storage device readable by machine, tangibly embodying a program of instructions executable by the machine to perform method steps for efficient interactions between a user and a computer system as recited in claim 18.
